(19) United States
(12) Patent Application Publication
(10) Pub. No.: US 2011/0063231 A1
(43) Pub. Date: Mar. 17, 2011

(54) Method and Device for Data Input

(75) Inventors: Thomas Jakobs, Alma, AR (US); Allen Baker, Bella Vista, AR (US)

(73) Assignee: InvoTek, Inc., Alma, AR (US)

(21) Appl. No.: 12/558,657

(22) Filed: Sep. 14, 2009

(51) Int. Cl. G06F 3/041

(52) U.S. Cl. 345/173

(57) ABSTRACT

A method and system of inputting data, including language and other forms of communication, into an electronic device is disclosed. The method and system are directed to reducing the number of keystrokes that a disabled person would need to make to use a computer or alternative communication device. The method and system according to the invention utilizes a virtual keyboard upon which a user makes an input pattern or “gesture”. The gesture is then transformed into a ranked list of language unit prefixes. Word prediction analysis then analyzes the list of language unit prefixes and develops a list of potential word or phrases that the user may select from.

### FIELD OF THE INVENTION

The present invention pertains to methods and devices to provide communication assistance for people with disabilities.

On-screen “virtual” keyboards enable people with disabilities to “type” into software applications using alternate computer access devices such as head trackers, eye trackers, and touch-screens. These virtual keyboards and alternate access devices often include word prediction and completion capabilities that reduce the number of keystrokes required to enter text, which can be of great benefit depending on the severity of disability of the user.

Word prediction and completion techniques have existed for several years. Generally, these known techniques reduce the number of keystrokes required to enter text by approximately 50%. Typically, word prediction works by predicting the next word to be typed based on the previous word in a sentence. Language models provide word frequency-of-occurrence statistics for possible next words given a previous word. Software then displays the predicted words in a list on the assistive device screen. The user selects the desired word if it is listed using his or her alternate access device.

If the prediction list does not contain the desired word, the user types the first letter of the desired word. Word completion software uses a language model to update the prediction list with the most likely words that begin with the typed letter and occur after the previous word in the sentence. This process continues (type a letter, update the list) until the user either selects a word from the word completion list or completes the word without assistance.

While word prediction and completion techniques aid those with disabilities by reducing the number of letters that must be accurately selected, they still require the accurate selection of several keys to enter most words. This can be a significant barrier to users with severe disabilities. Research in the disability field also indicates that the process of switching back and forth from composing text to reading lists makes the writing process more cognitively difficult than just writing alone adding another layer of difficulty for people who require such devices.

### OBJECT AND SUMMARY OF THE INVENTION

In view of the above, it is an object of the present invention, among others, to reduce the number of keys that must be accurately targeted to input a language unit (e.g., a word) into a computer using an on-screen virtual keyboard.

It is another object of the present invention to reduce the number of keys that must be targeted to input language units by transforming a sequence of approximate movements towards keys (a “gesture”) into the functional equivalent of actually targeting or “typing” a sequence of keys.

It is another object of the present invention to transform inflection locations, defined by changes in direction of the gesture or the speed of the gesture, to represent approximations to the location of desired keys.

It is another object of the present invention to limit the number of inflections in a gesture to a predefined number, making it possible to select the best inflections in the gestures as indicators of the keys targeted by the person making the gesture.

It is also an object of the present invention to determine the likelihood that a key was targeted based on its distance from an inflection, with shorter distances from an identified inflection indicating a greater likelihood that a key was targeted.

Briefly, and in general terms using exemplary language to aid but not limit the discussion, the above objects are met by the present invention which is directed to a method for inputting language into an electronic device having a virtual keyboard.

The virtual keyboard comprises keys associated with graphemes. As used herein, the term “grapheme” includes the individual units of written language (e.g., letters, punctuation, numerals, etc.) and the common combinations of graphemes (e.g., digraphs and trigraphs) that make up a single phoneme (e.g., sh, th, wh, tch, etc.) or words. The term grapheme also encompasses pictographs and ideograms for illiterate users or for languages based upon pictographs or ideograms.

The method according to the invention includes initiating an input path (or “gesture”) at an initial input point where the initial input point is at or near a first key which is usually associated with a grapheme, for example, by placing a cursor near a key associated with a grapheme and clicking a mouse. The cursor is dragged over the virtual keyboard to create an input path. In most instances the path taken by the cursor will have one or more angular or speed deviations or “inflections”.

As used herein the terms “input path” and “gesture” are mostly interchangeable and the use of one over the other is usually based upon the tenor of the discussion. The term input path is used when a more precise description may be needed.

A predefined number of inflections, N, for later identification along the input path is established to aid in the analysis of the input path by software.

The input path is maintained on the virtual keyboard then terminated.

The input path is then transformed or processed to identify inflections along the input path and the sequence of the inflections. The transformation or processing also includes determining if the predefined number of inflections were created.

Identified inflections are then associated with keys which are associated with graphemes. Analyzing the graphemes then allows a determination of possible language units (e.g., words) based upon the number and sequence of identified inflections and associated graphemes.

The method then provides a user with a ranked list of possible language units to be input to the electronic device. Language units may be automatically input into the device if certain threshold criteria are met. Alternatively, a user may manually select a language unit from the list or discard one or more language units. In summary, the invention includes a method or process for transforming a gesture into language.

The invention also comprises a system or device for receiving language data input. The precise makeup of the system or device will depend upon the particular disability of the user. However, it is anticipated that embodiments of the invention will include a virtual keyboard where the virtual keyboard has a set of keys associated with graphemes.

The device according to the invention will also contain and utilize an input device which may vary from user to user and is discussed more fully later. An output device for displaying the results of the input path transformation will also be needed. The device according to the invention also utilizes at least one database (preferably more than one database) for storing a list of language units. The device will further have a processor coupled to the input device, the output device, and the database.

The processor utilized in the practice of the invention will have several components to aid in the transformation of the input path into language units. A first component may be present for recording and analyzing a communicative input path on the virtual keyboard, where the input path includes an initial input point and no more than N identified inflections, wherein N is a predetermined number. The processor also utilizes a second component for associating identified inflections with graphemes and a third component for identifying a list of prefixes of language units based upon the graphemes.

A fourth component determines a relative ranking of possible language units based upon the identified prefixes. This is followed by a fifth component presenting one or more of the ranked language units to the user via the output device.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a sample interface for a gesture enhanced word prediction program;

FIG. 2 is an overview flow diagram for the gesture processing software;

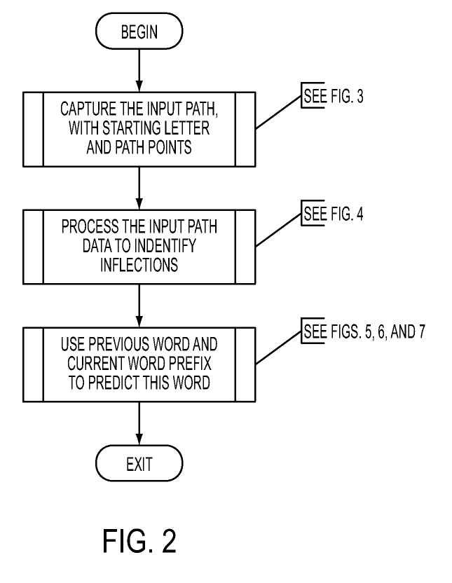

FIG. 3 is a flow diagram of the gesture capture algorithm;

FIG. 4 is a flow diagram of the gesture analysis software for determining inflection points;

FIG. 5 is a flow diagram for generating prefixes;

FIG. 6 is a flow diagram for word prediction; and

FIG. 7 is a flow diagram for auto-insertion of language units.

FIG. 8 is a schematic of a system according to the invention.

### DETAILED DESCRIPTION

The present invention will now be described more fully hereinafter with reference to the accompanying drawings, in which a preferred embodiment of the invention is shown. However, this invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention provides an improved data entry method preferentially designed for a person with a disability in which the person uses one of several possible input means to enter virtual keystrokes on a virtual keyboard. The input means may include any of the input means currently available in the marketplace for alternative access devices, including but not limited to, limb or digit movement tracking systems such as a computer mouse, trackball, or a touch screen; head movement tracking systems such as those that direct or reflect electromagnetic radiation to an electromagnetic sensitive screen; eye movement tracking systems; light responsive screens; etc.

A particularly well suited device is the ACCUPOINT system from InvoTek of Alma, Ark., which tracks the movement of any body part in a non-contact manner and is usually used for tracking head movement.

More specifically, the invention encompasses a method of inputting language into an electronic device having a virtual keyboard wherein the virtual keyboard is comprised of virtual keys associated with graphemes. The remainder of this specification may use the terms “words” and “letters” in place of the terms “language unit” and “grapheme”, respectively. This is done to make the discussion more easily understood by the reader. This literary convenience should not be interpreted to limit the scope of the invention.

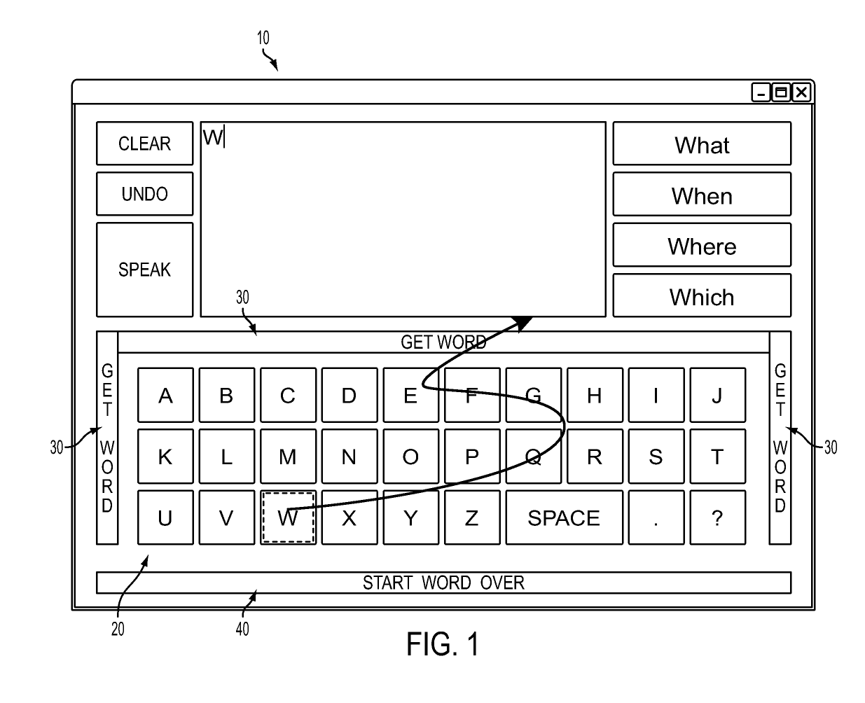

FIG. 1 is an example of an interface 10 for a method for inputting language according to the invention. The interface 10 shown in FIG. 1 is representative of an interface having a virtual keyboard 20. The virtual keyboard 20 is shown as having an alphabetical key sequence. A virtual keyboard having a typical “QWERT” key sequence (or any other type of sequence) is also contemplated for use in the practice of the invention.

In very broad terms, the invention is a method that allows a user to identify a prefix (the first few letters of a word) by creating an input path along a virtual keyboard. As used herein, the term “input path” (or “gesture”) is defined as the overall movement (and recordation) of an input means (e.g., a mouse, head tracker, finger or stylus on a touch screen, etc.) as it moves along a virtual keyboard. Typically, creating an input path includes initiating an input path at an initial input point (e.g., the starting point for a cursor or stylus); maintaining the input path on the virtual keyboard (e.g., moving a cursor or stylus around on the virtual keyboard), then terminating the input path.

Each of the above steps for initiating, maintaining, and terminating the input path may be accomplished in a variety of ways depending upon the input device used in the practice of the invention.

The step of initiating the input path may be accomplished by placing a stylus on a touch sensitive screen at or near a particular point or key (e.g., the first letter in a word). If a mouse or alternative cursor moving device (e.g., the AccuPoint system of InvoTek) is used the user can click or dwell over the desired key. Similarly, switch closure can be used to initiate an input path. Thus the step of initiating an input path is somewhat dependent on the input means and the invention encompasses any method of initiating an input path.

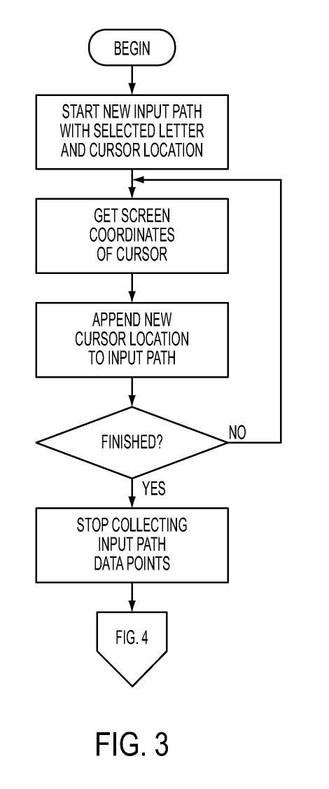

Once the input path is initiated the input path is captured by the software according to FIG. 3. The software monitors the virtual keyboard and/or cursor position and the activation method available to the user for indicating the initial input point (e.g., contacting a touch screen, clicking a mouse, etc.). Once the initial input point (e.g., a key associated with a letter) is selected, the software samples the cursor's position 30 times each second and records its location as the input path is maintained (i.e., continually moved along the virtual keyboard) and appends each new cursor (or stylus) location to the forming input path, as described in FIG. 3.

The input path is then terminated. The input path may be terminated in any number of ways depending on the input device and/or the interface. For example, if a stylus is used to contact a virtual keyboard on a touch pad the stylus may simply be lifted from the pad to terminate the input path. If an onscreen cursor is used for a computer screen having a virtual keyboard, the device which controls the cursor (e.g., a mouse or head tracker) can move the cursor to a designated “termination area” on the screen (e.g., a rectangular “enter” button) or simply track the cursor to a point off of the virtual keyboard (e.g., cross a boundary of the keyboard).

FIG. 1 shows two such termination areas, 30 and 40. One area, 30, encompasses the top and side boundaries of the virtual keyboard, 20. The software can be set such that if the cursor crosses this boundary the input path is terminated. Alternatively, the bottom boundary, 40, of the virtual keyboard can be used to terminate an input path and discard any predicted words in case of gesturing in an incorrect manner.

FIG. 1 also provides an example of creating an input path according to the invention. The cursor starts at an initial input point representing a grapheme, in this case the letter “W”. Once a letter is selected, the user moves the cursor towards a desired second letter which is associated with another key. Typically, a user either slows the movement of the cursor at or near the next desired letter to create a speed inflection or creates an angular inflection at or near the letter and then continues toward the next letter, where another inflection point may be created by a user.

In the example provided in FIG. 1 the user dwelled on the letter “W” and created two angular inflection points: one near the letter cluster G, H, Q, R and one over the letter E. The user then exited the on-screen virtual keyboard to end the gesture (or released contact with a touch screen) after completing the final inflection point.

Having seen how an input path is created we now turn to how the input path is analyzed. The software analysis of the input path actually begins prior to the initiation of the input path by setting various parameters within the software. For example, one aspect of the invention is to reduce or eliminate the need for a disabled person to spell an entire word. One method of doing this is to only require a user to generally identify the first few letters of a word. Statistical language analysis is then used to predict the complete word. Therefore, in a preferred embodiment of the invention, the user is only required to make a few inflections to identify the first few letters of a word.

The precise number of inflections to be entered by a user is somewhat user dependent (and can be tailored to suit the individual user) but should not be so small as to hinder successful prediction of a language unit and not so large as to make use of the invention difficult. In most instances the number of inflections, N, to be detected by the software will be set from 2 to 4 with 3 being most likely to produce the proper balance between ease of use and accurate language unit prediction. Note that these are guidelines and the number of inflections, N, can be set to any number.

Once the number of acceptable inflections is determined and entered into the software, the software begins analyzing the input path (even as it is being created) to identify one or more possible inflections along the input path. This is accomplished by establishing minimum parameters for identifying an inflection and eliminating one or more of these possible inflections based upon whether the possible inflections meet or exceed the predetermined parameters. This aids in eliminating unintentional inflections by a user.

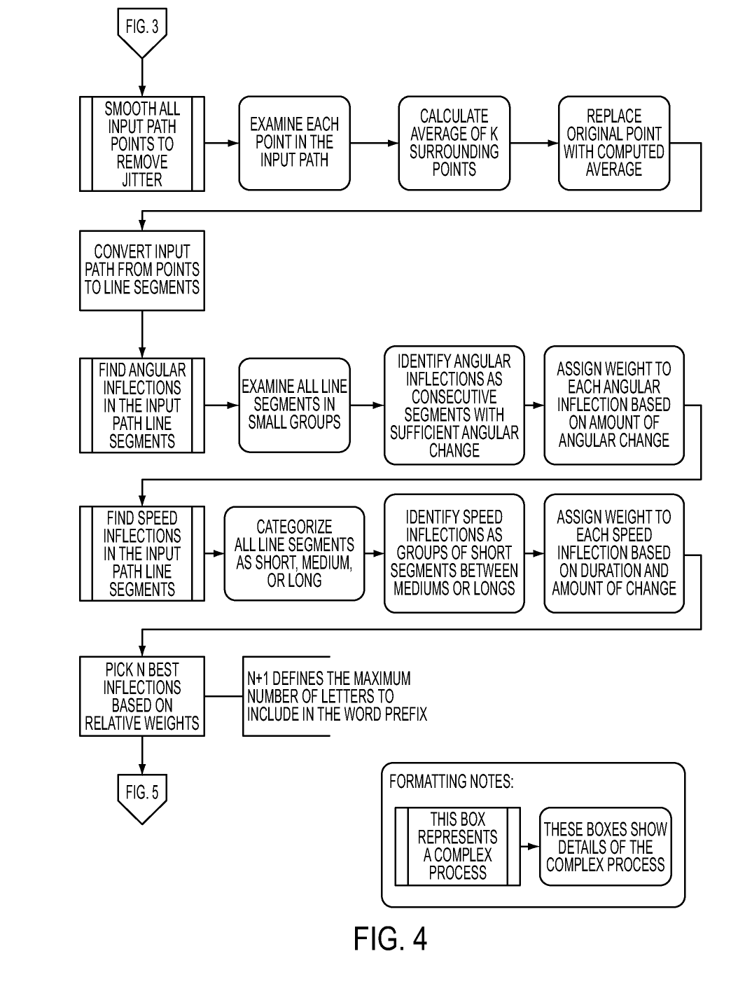

Turning now to FIG. 4, this initial analysis by the software begins by “smoothing” the input path to remove jitter that could be interpreted as an inflection point. FIG. 4 describes an averaging process that could be used in the practice of the invention. However, other various statistical methods can be used to smooth the data. After smoothing, the input path is converted from a sequence of points to a sequence of line segments and analyzed to identify an initial set of angular inflections and speed inflections.

Angular inflections are identified by measuring the slope between consecutive groups of line segments. Each angular inflection is assigned a weight based on the amount of angular change it exhibits and the number of line segments involved. Short groups with large angular changes (i.e., sharp turns) are assigned higher weights than longer groups with smaller angular changes (i.e., wide turns).

In a similar way, consecutive groups of line segments are categorized as short (close together in time and distance), medium, and long. Any group of line segments that are categorized as short and surrounded by groups that are medium or long is identified as a speed inflection point. For example, if the user was quickly moving the cursor the individual input points during this movement would be farther apart for a given time frame than they would be when the user slowed down to make an inflection over a letter. The result is that shorter line segments usually occur at locations where the user was trying to slow down or pause near a particular key.

Each speed inflection is also assigned a weight based on the number of line segments involved and the “depth” of the pause—the actual amount of speed change between the segments within the group and those in the surrounding groups. Short groups with deep pauses are assigned higher weights than longer groups with more shallow pauses.

The lists of angular inflections and speed inflections are each sorted by weight, then combined, favoring overlapping angular and speed inflections to create a sequence of inflections that were most probably intended by the user.

If the software detects fewer than the predefined number of inflections, N, the software gives preference to short words in the language model. If the software detects greater than the predefined number of inflections, N, it eliminates the weakest inflections to limit the total number of inflections to the predefined number and gives preference to words that are as long as or longer than one (1) plus the predefined number of inflections.

For example, if N was set to 3 and if a user started input by placing cursor on the letter “w” then made 8 possible inflections, the software would pick the best 3 inflections and look for a 4 (N plus 1) letter word or a longer word.

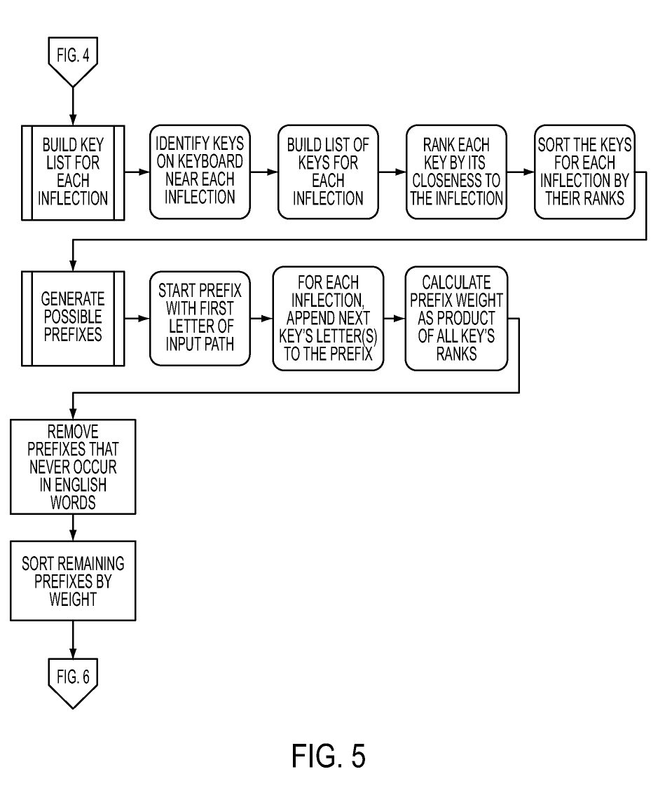

Turning now to FIG. 5, each inflection is examined to determine which keys on the virtual keyboard are closest to the inflection. The letters corresponding to each of these keys are associated with the inflection, along with a ranking as to how likely each letter was the intended letter, based on the distance from the inflection point to the center of each key. Close keys get higher rankings than distant keys. The keys for each inflection are sorted by their rank and a list of possible prefixes is generated from the letters associated with each key.

Each word prefix consists of the gesture's starting letter, concatenated with the letters from each of the best inflections. Each prefix is assigned a weight, calculated as the product of the ranks of each of the letters that make up the prefix. The list of possible prefixes is filtered to eliminate letter combinations that do not occur in the language of interest, and then the prefix list is sorted by weight, putting those with the highest weight at the head of the list.

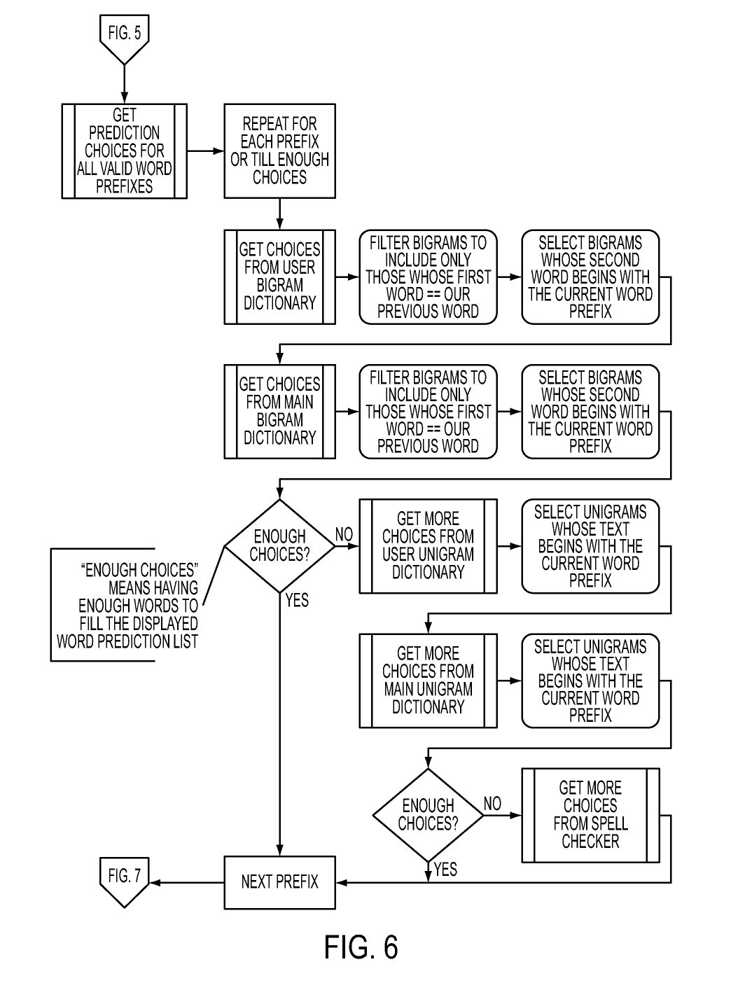

Turning now to FIG. 6, once the input path is processed, the inflection points are determined, and possible prefixes are identified, the language unit (e.g., word) prediction process begins using a Bigram statistical analysis. This process uses two pre-built dictionaries—one for Bigrams (word pairs), and one for Unigrams (single words). It also uses two user created dictionaries containing Bigrams and Unigrams that the user has entered during previous data entry sessions. To develop a list of probable words (the Prediction List) each prefix is paired with the previous word in the user's text, and the two Bigram dictionaries are queried for word pairs with the same first word plus second words that start with the current prefix. If there are not enough possibilities to fill the displayed word prediction list, the prefix is used to query both of the Unigram dictionaries for popular words that start with the prefix letters. If there are still not enough possibilities to fill the displayed word prediction list, the prefix is used to query a spell checker for rare words and for commonly-misspelled words. All these queries add to the Prediction List.

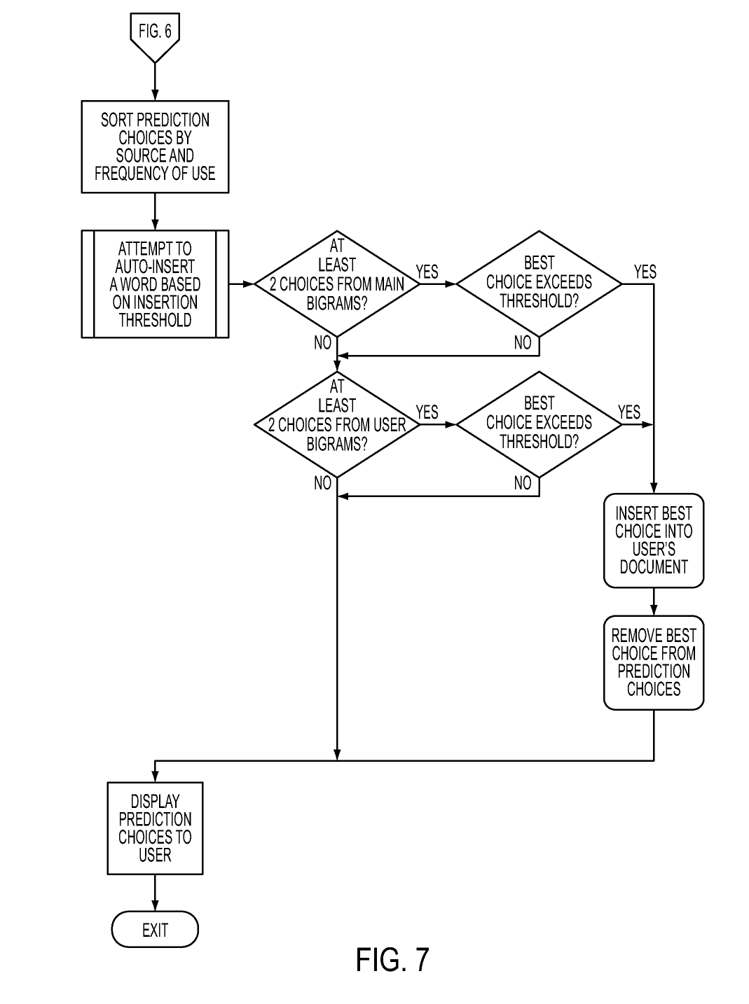

Turning now to FIG. 7, if the Prediction List contains at least 2 words from the main Bigram dictionary, these two words are ranked based on their usage count (from the dictionary) to determine whether the first word meets a predefined comparative threshold (for example, the first word's count is twice the second word's count). That determines whether it should be automatically inserted into the user's text. If not, the same process is used with the words from the User Bigram dictionary. If either case causes a word to be automatically inserted, that word is removed from the Prediction List. Finally, the contents of the Prediction List are displayed to the user for manual selection, using their current access method.

After the software completes the gesture word prediction process, the user has several choices. The user can accept the word automatically inserted in the sentence by selecting the first letter of the next word thereby triggering the gesture process described above for the next word. The user can also begin typing using the chosen input means, without invoking the gesture process. The user can select one of the words in the word prediction list and replace the word automatically inserted into the text. Or, the user can virtually “press” the “undo” button (see FIG. 1, element 30) and discard all but the first letter of the inserted word. The user would then select additional letters, using the same technique they used to select the first letter, to spell the word. As the user continues the spelling process, the word prediction software will update the word prediction list after each letter is entered in an effort to predict the word intended by the user. This process ends when the user either selects a word from the word prediction list or enters a space or punctuation mark, indicating that the word is complete. The next letter entered by the user starts the gesture process over again.

In another embodiment of the invention, the input path is not initiated by specifically identifying an initial input point but by moving an input means from an area outside of a virtual keyboard into the virtual keyboard (e.g., dragging the cursor across a boundary into the virtual keyboard). This embodiment may be useful for those individuals who cannot maintain enough stability to specifically place an input means directly on the first grapheme of a language unit.

In this embodiment, the method according to the invention is essentially the same as the prior embodiment with the exception that the first grapheme of the language unit is determined by identifying an inflection rather than the user initiating the input path at the first grapheme. Because the initial grapheme is identified by an inflection rather than direct identification the relationship between the predefined number of inflections, N, and the development of the prefix is a little different.

For input sessions where the number of inflections is less than or equal to the predefined number of inflections, N, the user is presented with a list of language units (e.g., words) where the number of graphemes in the language units is less than or equal to than the number of identified inflections.

For input sessions where the number of inflections is greater than the predefined number of inflections, N, the user is presented with a list of language units where the number of graphemes in each language unit is equal to the number of predefined inflections.

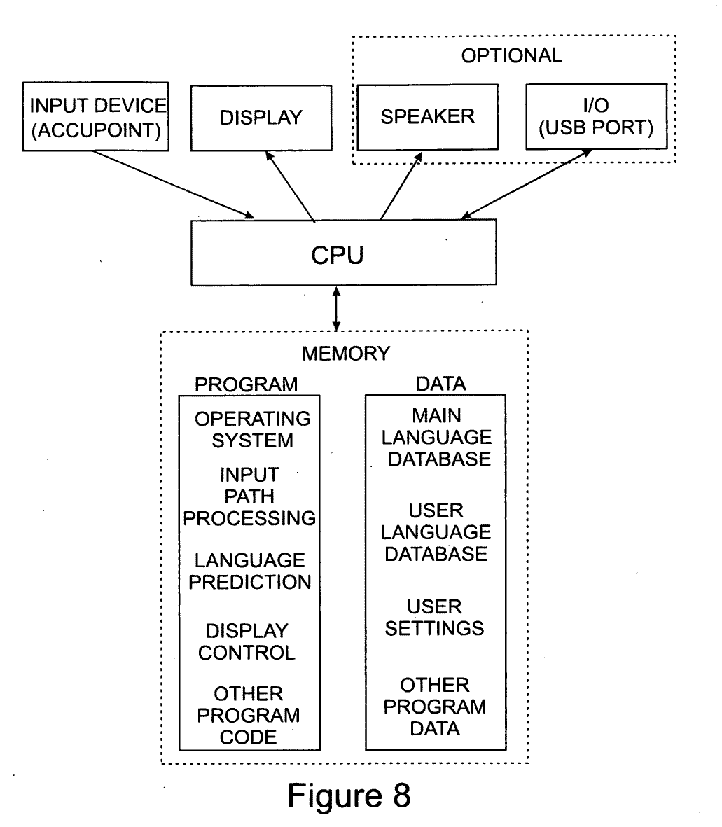

In a final embodiment, the invention provides a system for receiving language input data utilizing the method according to the invention. A schematic of such a system is shown in FIG. 8. The system according to the invention may be constructed using items that are currently commercially available (e.g., input devices such as the AccuPoint device from InvoTek, off the shelf CPUs, off the shelf touch screens, etc.). Thus, the physical make up of the system (the actual hardware components) may vary substantially from embodiment to embodiment depending on the particular needs of the disabled person. For example, some users may desire to have a speech synthesizer and speakers attached to their system. However, it is envisioned that a successful system will contain the following components.

A successful system according to the invention will comprise a virtual keyboard with the virtual keyboard having a set of keys associated with graphemes. The system will also have an input device such as those previously discussed.

The system should have an output display suitable for the needs of the particular user such as a liquid crystal display (LCD) or a computer screen for those users that are not visually impaired. The system requires a database for storing a list of language units and a processor coupled to the input device, the output device, and the database.

The precise architecture of the system may vary depending upon the particular preferences of the constructing engineer but should contain a first component for recording and analyzing a communicative input path on the virtual keyboard where the analyzed input path includes an initial input point and no more than N identified inflections, wherein N is a predetermined number.

The system will also comprise a second component for associating identified inflections with graphemes and a third component for identifying a list of prefixes of language units based upon the graphemes. A fourth component will determine a relative ranking of possible language units based upon the identified prefixes and a fifth component will present one or more of the ranked language units to the user via the output device.

The present invention provides a data entry method and system that reduces the amount of information that must be entered into the computer to produce messages by combining the first letter of a word, a gesture with a predefined maximum number of expected inflections, and word prediction.

As will be apparent to those skilled in the art, various changes and modifications may be made to the illustrated gesture-enhanced word prediction software of the present invention without departing from the spirit and scope of the invention as determined in the appended claims and their legal equivalent.

In the drawings and specification, there have been disclosed typical embodiments on the invention and, although specific terms have been employed, they have been used in a generic and descriptive sense only and not for purposes of limitation, the scope of the invention being set forth in the following claims.

The present invention reduces the number of keys that must be accurately targeted, potentially providing a keystroke savings of greater than 70%. It also significantly reduces the number of times the user must switch from composing text to reading the prediction list.

1. A method of inputting language into an electronic device having a virtual keyboard, wherein the virtual keyboard comprises keys associated with graphemes, the method comprising:
initiating an input path at an initial input point where the initial input point is at or near a first key;
establishing a predefined number of inflections, N, to be detected along the input path;
maintaining the input path on the virtual keyboard;
terminating the input path;
processing the input path to identify inflections along the input path and the sequence of the inflections;
determining if the predefined number of inflections were created;
associating identified inflections with keys;
determining possible language units based upon the number and sequence of inflections and associated graphemes; and
providing a user with a ranked list of possible language units to be input to the electronic device.

2. A method according to claim 1 wherein the number of identified inflections is less than the predefined number of inflections, N, and the user is presented with a list of language units where the number of graphemes in the language units is equal to 1 plus the number of inflections.

3. A method according to claim 1 wherein the input path contains at least the predefined number of inflections, N, and the user is presented with a list of language units where the number of graphemes in each language unit is at least equal to the number of predefined inflections, N, plus 1.

4. A method according to claim 1 wherein inflections are selected from the group consisting of angular inflections and speed inflections.

5. A method according to claim 4 wherein the step of processing the input path to identify inflections further comprises the step of assigning relative weights to the angular and speed inflections.

6. A method according to claim 5 further comprising the steps of sorting and combining the angular speed inflections then favoring overlapping angular and speed inflections.

7. A method according to claim 6 wherein the step of associating inflections with keys further comprises identifying keys near each ranked inflection.

8. A method according to claim 7 wherein the step of determining possible language units further comprises generating possible language unit prefixes based upon the initial input point and its associated grapheme, along with the graphemes associated with each ranked inflection.

9. A method according to claim 8 further comprising eliminating possible language unit prefixes that are not found in the language of interest.

10. A method according to claim 8 wherein the step of determining possible language units further comprises generating a list of possible language units containing the prefixes and filtering the list of possible language units using a statistical analysis.

11. A method according to claim 10 wherein the step of providing a user with a ranked list of possible language units comprises ranking the filtered list of possible language units.

12. A method according to claim 11 wherein the first ranked language unit meets an insertion threshold and is automatically inserted into the electronic device.

13. A method according to claim 11 wherein none of the ranked language units meet a threshold for automatic insertion and the user selects a language unit from the ranked list.

14. A method according to claim 1 wherein none of the language units in the ranked list provided to the user contains the language unit desired by the user, the method further comprising the step of discarding the ranked list of language units.

15. A method according to claim 1 wherein the steps of initiating, maintaining, and terminating an input path is accomplished using an input means.

16. A method of inputting language into an electronic device having a virtual keyboard, wherein the virtual keyboard comprises keys associated with graphemes and at least one defined boundary, the method comprising:
initiating an input path by crossing a boundary of the virtual keyboard;
establishing a predefined number of inflections, N, to be detected along the input path;
maintaining the input path on the virtual keyboard;
terminating the input path;
processing the input path to identify inflections along the input path and the sequence of the inflections;
determining if the predefined number of inflections were created;
associating identified inflections with graphemes;
determining possible language units based upon the number and sequence of identified inflections and associated keys; and
providing a user with a ranked list of possible language units to be input to the electronic device.

17. A method according to claim 16 wherein the number of inflections is less than or equal to the predefined number of inflections, N, and the user is presented with a list of language units where the number of graphemes in the language units is equal to the number of identified inflections.

18. A method according to claim 16 wherein the input path contains more than the predefined number of inflections, N, and the user is presented with a list of language units where the number of graphemes in each language unit is equal to the number of predefined inflections.

19. A method according to claim 16 wherein inflections are selected from the group consisting of angular inflections and speed inflections.

20. A system for receiving language data input, the device comprising:
a virtual keyboard, said virtual keyboard having a set of keys associated with graphemes;
an input device;
an output device;
a data base for storing a list of language units; and
a processor coupled to the input device, the output device, and the database, the processor comprising:
a first component for recording and analyzing a communicative input path on the virtual keyboard, where the input path includes an initial input point and no more than N identified inflections, wherein N is a predetermined number;
a second component for associating identified inflections with graphemes,
a third component for identifying a list of prefixes of language units based upon the graphemes,
a fourth component for determining a relative ranking of possible language units based upon the identified prefixes, and
a fifth component for presenting one or more of the ranked language units to the user via the output device.
